(19) United States
(12) Patent Application Publication
(10) Pub. No.: US 2026/0019948 A1
(43) Pub. Date: Jan. 15, 2026

(54) ELECTRONIC APPARATUS AND CONTROL METHOD

(71) Applicant: SEIKO EPSON CORPORATION, Tokyo (JP)

(72) Inventor: Junpei KOIZUMI, Matsumoto (JP)

(21) Appl. No.: 19/263,551

(22) Filed: Jul. 9, 2025

(30) Foreign Application Priority Data
Jul. 11, 2024 (JP) 2024-111494

(51) Int. Cl. H04W 52/02; H04W 76/18

(52) U.S. Cl. CPC H04W 52/0235; H04W 76/18

(57) ABSTRACT

An electronic apparatus 100 includes a wireless communicator 120 that performs wireless communication with a communication apparatus 200, and a processing section 110 that includes a communication controller 114 that controls communication of the wireless communicator 120. When an event that causes a shift of a communication connection between the processing section 110 and the wireless communicator 120 from a power-saving mode to a non-power-saving mode occurs, the communication controller 114 transmits a signal for searching for the communication apparatus 200 and detects a failure of the wireless communication depending on whether a response to the signal is received from the communication apparatus 200.

The present application is based on, and claims priority from JP Application Serial Number 2024-111494, filed Jul. 11, 2024, the disclosure of which is hereby incorporated by reference herein in its entirety.

### BACKGROUND

### 1. Technical Field

The present disclosure relates to an electronic apparatus and a control method.

### 2. Related Art

In a wireless communication, such as Wi-Fi (registered trademark), a failure may occur in the wireless communication between an electronic apparatus and another apparatus. In this regard, for example, JP-A-2018-15997 discloses a technique in which, when a communication error occurs in a printing apparatus capable of communicating with a terminal apparatus, a communication controller transmits an initialization signal to a communicator to solve the communication error.

Even when a failure occurs in wireless communication of an electronic apparatus, when the occurrence of the failure can be detected, the failure can be resolved by the electronic apparatus performing a predetermined process for recovery. Therefore, in order not to reduce the convenience for the user, a technique for detecting a failure is important. However, the existing failure detection technologies have room for improvement in terms of appropriate detection of a failure.

### SUMMARY

According to an aspect of the present disclosure, an electronic apparatus includes a wireless communicator that performs wireless communication with a communication apparatus, and a processing section that includes a communication controller that controls communication of the wireless communicator. When an event that causes a shift of a communication connection between the processing section and the wireless communicator from a power-saving mode to a non-power-saving mode occurs, the communication controller transmits a signal for searching for the communication apparatus and detects a failure of the wireless communication depending on whether a response to the signal is received from the communication apparatus.

According to another aspect of the present disclosure, a control method is a method for controlling an electronic apparatus including a wireless communicator that performs wireless communication with a communication apparatus and a processing section including a communication controller that controls communication of the wireless communicator. When an event that causes a shift of a communication connection between the processing section and the wireless communicator from a power-saving mode to a non-power-saving mode occurs, a signal for searching for the communication apparatus is transmitted, and a failure of the wireless communication is detected depending on whether a response to the signal is received from the communication apparatus.

### BRIEF DESCRIPTION OF THE DRAWINGS

FIG. 1 is a diagram schematically illustrating an example of a configuration of a communication system according to an embodiment;

FIG. 2 is a block diagram illustrating an example of a configuration of an electronic apparatus according to the embodiment;

FIG. 3 is a diagram illustrating an example of a specific configuration of a processing section and a wireless communicator in the electronic apparatus according to the embodiment;

FIG. 4 is a flowchart of an example of a flow of an operation of the processing section;

FIG. 5 is a sequence chart of an example of operations of the electronic apparatus and a communication apparatus according to the embodiment;

FIG. 6 is a sequence chart of a first operation example of an electronic apparatus according to a comparative example; and

FIG. 7 is a sequence chart of a second operation example of the electronic apparatus according to the comparative example.

### DESCRIPTION OF EMBODIMENTS

Hereinafter, an embodiment will be described with reference to the drawings. For clarification of the description, in the following description and drawings, omissions and simplifications are made as appropriate. In the drawings, the same elements are denoted by the same reference signs, and redundant description thereof will be omitted as appropriate. In addition, not all of the features or steps shown in any one of the drawings to describe an exemplary embodiment are necessarily essential, and some features or steps may be omitted. Furthermore, the order of the steps described in any of the drawings may be changed as appropriate.

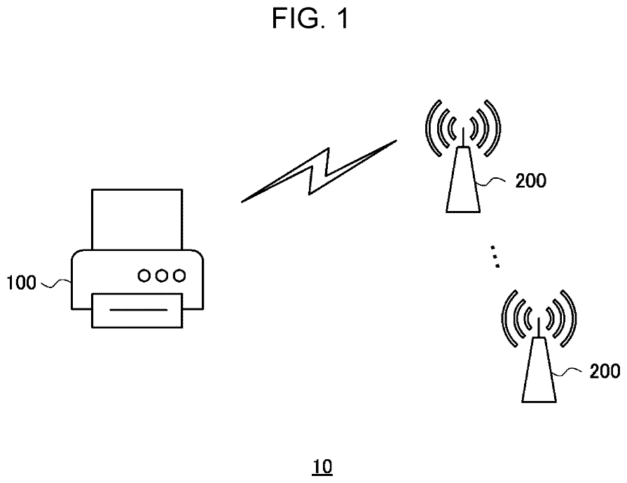

FIG. 1 is a diagram schematically illustrating an example of a configuration of a communication system 10 according to this embodiment. The communication system 10 includes an electronic apparatus 100 and a communication apparatus 200 capable of performing wireless communication with the electronic apparatus 100.

The communication apparatus 200 is any device that performs wireless communication with the electronic apparatus 100. In this embodiment, as an example, the communication apparatus 200 is an access point. The communication system 10 may include a plurality of communication apparatuses 200. For example, when the communication system 10 is configured as a network environment in which a plurality of access points are arranged in a space, such as mesh Wi-Fi (registered trademark), the communication system 10 may include a plurality of communication apparatuses 200. The communication apparatus 200 periodically (for example, every 100 milliseconds) transmits a beacon which is a signal for notifying peripheral devices of the presence of the communication apparatus 200. The beacon may include a service set identifier (SSID) of the communication apparatus 200.

The electronic apparatus 100 may be any device having a configuration for performing wireless communication. In this embodiment, a technique in which the electronic apparatus 100 detects a failure in wireless communication occurring in the electronic apparatus 100 will be described. Although a configuration in which the electronic apparatus 100 is an apparatus having a printing function, that is, a printer, is described in this embodiment, the electronic apparatus 100 does not necessarily have a printing function. Furthermore, the electronic apparatus 100 may have one or more other functions instead of the printing function or together with the printing function. For example, the electronic apparatus 100 may have a scanner function, a facsimile function, a copy function, or the like.

As described above, the electronic apparatus 100 performs wireless communication with another device, such as the communication apparatus 200. The wireless communication performed by the electronic apparatus 100 may be wireless communication according to a known wireless communication standard. In this embodiment, for example, the electronic apparatus 100 performs communication using a Wi-Fi (registered trademark) system. The Wi-Fi system corresponds to a wireless communication system based on, for example, the IEEE (Institute of Electrical and Electronics Engineers) 802.11 standard or a standard conforming thereto.

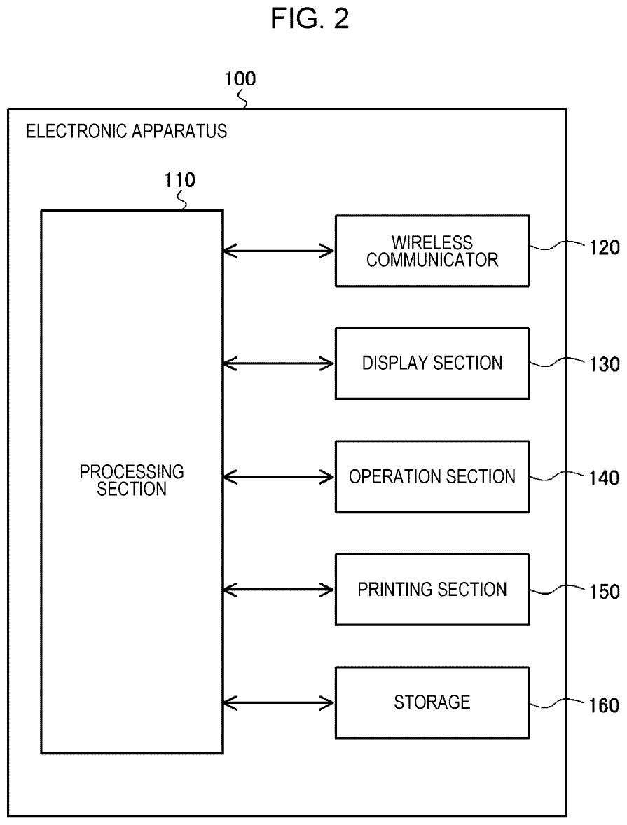

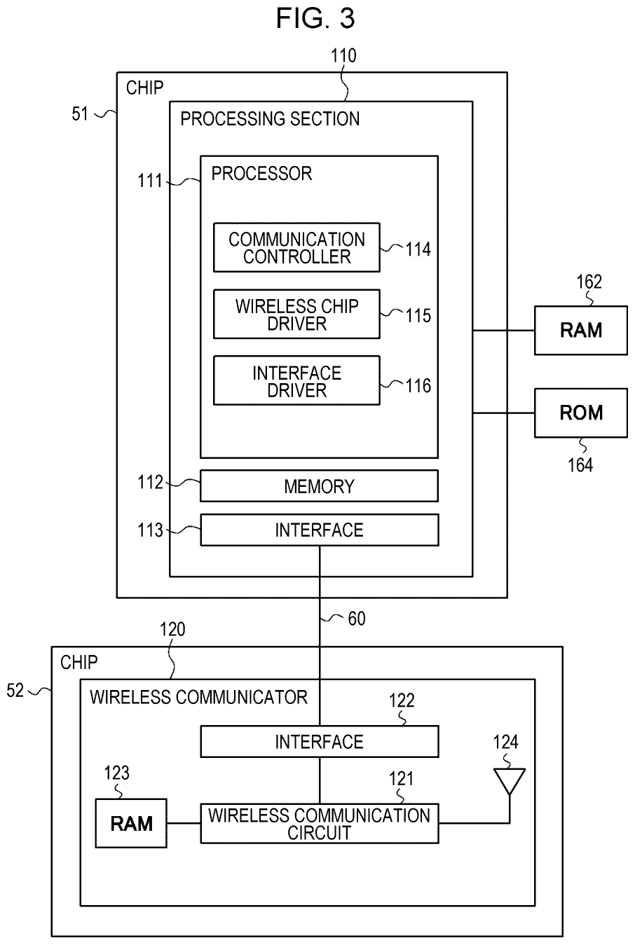

FIG. 2 is a block diagram illustrating an example of a configuration of the electronic apparatus 100 according to this embodiment. FIG. 3 is a diagram illustrating an example of a specific configuration of a processing section 110 and a wireless communicator 120 in the electronic apparatus 100.

As illustrated in FIG. 2, the electronic apparatus 100 includes the processing section 110, the wireless communicator 120, a display section 130, an operation section 140, a printing section 150, and a storage 160.

The processing section 110 controls individual sections of the electronic apparatus 100. The sections of the electronic apparatus 100 include, for example, the wireless communicator 120, the display section 130, the operation section 140, the printing section 150, and the storage 160. In this embodiment, the processing section 110 has a function as a computer, and is configured as a system on a chip (SoC) as an example. Specifically, as shown in FIG. 3, the processing section 110 is included in a chip 51. The chip 51 is, for example, a semiconductor chip. As described above, in this embodiment, the processing section 110 is configured by an integrated circuit. The processing section 110 includes a processor 111, a memory 112, and an interface 113. The processor 111 performs processing related to the wireless communication function of the electronic apparatus 100. The processing section 110 may include another processor that performs processing related to another function of the electronic apparatus 100, and the processor 111 may perform processing related to another function in addition to the processing related to the wireless communication function.

The wireless communicator 120 performs wireless communication with an apparatus other than the electronic apparatus 100, such as the communication apparatus 200, in conformity with, for example, a predetermined wireless communication standard. For example, the wireless communicator 120 performs wireless communication conforming to a predetermined wireless local area network (LAN) standard. In this embodiment, specifically, wireless communication compliant with, for example, the Wi-Fi (registered trademark) standard, which is one of wireless LAN standards, is performed. In this embodiment, as shown in FIG. 3, the wireless communicator 120 is included in a chip 52. The chip 52 is, for example, a semiconductor chip. As described above, in this embodiment, the wireless communicator 120 is configured by an integrated circuit. Note that the wireless communicator 120 may include a wireless communication circuit compliant with a standard other than the wireless LAN standard. For example, the wireless communicator 120 may include a wireless communication circuit of a short-range wireless communication standard, such as Bluetooth (registered trademark). Specifically, the wireless communicator 120 may include a wireless communication circuit compliant with the Bluetooth Low Energy (BLE) standard.

The display section 130 and the operation section 140 are user interfaces. The display section 130 is configured by a display or the like that displays various types of information for the user. The operation section 140 is configured by a button or the like that accepts an input operation performed by the user. Note that the display section 130 and the operation section 140 may be integrally configured as a touch panel or the like.

The printing section 150 has a printing function for forming an image on a printing medium, such as a sheet. The printing section 150 includes a print engine. The print engine is a mechanical component that performs printing of an image on a printing medium by using coloring material. The print engine may include, for example, a mechanism that performs printing using ink by an ink jet method. Alternatively, the print engine may include, for example, a mechanism that performs printing using toner by an electrophotographic method. In addition, the print engine may include a transport mechanism that transports printing media.

The storage 160 stores various types of information, such as data and programs. The processing section 110 and the wireless communicator 120 may use, for example, the storage 160 as a work area. The storage 160 may be a semiconductor memory, such as a static random access memory (SRAM) or a dynamic random access memory (DRAM), a register, a magnetic storage device, or an optical storage device. The storage 160 may store data transmitted from another device by wireless communication. The data may be used for printing performed by the printing section 150.

Hereinafter, the processing section 110 and the wireless communicator 120 in the electronic apparatus 100 will be described in detail with reference to FIG. 3.

The processing section 110 includes the processor 111, the memory 112, and the interface 113. The processor 111 is, for example, a central processing unit (CPU), but may be a graphics processing unit (GPU), a digital signal processor (DSP), or the like. The memory 112 is configured by a volatile memory, a nonvolatile memory, or a combination thereof. The memory 112 is used to store a program to be executed by the processor 111, data to be used for various processes of the processing section 110, and the like. The processor 111 performs a process for realizing individual functions of the processing section 110 illustrated in FIG. 3 by reading and executing the programs stored in the memory 112. Note that the processor 111 may use a random access memory (RAM) 162 or a read only memory (ROM) 164 instead of the memory 112 or in addition to the memory 112. In this embodiment, the processor 111 specifically performs processing of a communication controller 114, processing of a wireless chip driver 115, and processing of an interface driver 116. The communication controller 114, the wireless chip driver 115, and the interface driver 116 will be described later. Note that the processor 111 may further perform processing other than these.

The interface 113 is used for performing, for example, wired communication among internal devices of the electronic apparatus 100. Specifically, the interface 113 is an interface circuit for the processing section 110 to communicate with the wireless communicator 120. The interface 113 is, for example, a serial interface capable of high-speed serial transfer. Specifically, the interface 113 is, for example, an interface of a communication standard of a universal serial bus (USB), but may be an interface of another communication standard. The processing section 110 may be connected to the RAM 162 and the ROM 164 constituting the storage 160 of FIG. 2. The RAM 162 and the ROM 164 may be included in the chip 51 or the processing section 110. The RAM 162 is, for example, an SRAM or a DRAM, and may be used as a work area of the processing section 110. The ROM 164 is a memory that can retain information even when power supply is cut off. The ROM 164 may be a ROM that is called a nonvolatile memory, such as an electrically erasable programmable read-only memory (EEPROM), capable of electrically deleting data, or may be a mask ROM.

The wireless communicator 120 includes a wireless communication circuit 121, an interface 122, a RAM 123, and an antenna 124. Note that, as described above, the wireless communication circuit 121 may include different wireless communication circuits of different standards, such as wireless LAN and short-range wireless communication.

The wireless communication circuit 121 performs wireless communication with an external device using the antenna 124. The wireless communication circuit 121 may include, for example, a transceiver that is a circuit of a physical layer of wireless communication and a communication processing circuit that performs processing of a link layer. The transceiver includes, for example, a transmission circuit and a reception circuit for wireless communication. The communication processing circuit can be realized by a processor, such as a CPU, for example. The interface 122 is, for example, a serial interface capable of performing high-speed serial transfer, and is an interface of the same communication standard as the interface 113 of the processing section 110. For example, the interface 122 is an interface compliant with the USB communication standard. The interface 113 of the processing section 110 and the interface 122 of the wireless communicator 120 are connected to each other via a bus 60. The RAM 123 temporarily stores various types of data and programs. The communication processing circuit of the wireless communication circuit 121 may operate using the RAM 123 as a work area.

Next, the wireless chip driver 115, the interface driver 116, and the communication controller 114, which are processed by the processing section 110, will be described.

The wireless chip driver 115 is a device driver of the wireless communicator 120. That is, the wireless chip driver 115 is software for operating the wireless communicator 120. Specifically, the wireless chip driver 115 is software, such as a program for controlling an operation of the wireless communication circuit 121 of the wireless communicator 120.

The interface driver 116 is a device driver of the bus 60 for the processing section 110 to be communicatively connected to the wireless communicator 120. That is, the interface driver 116 is software that controls a communication connection between the processing section 110 (chip 51) and the wireless communicator 120 (chip 52). In this embodiment, the interface driver 116 is specifically a USB host driver. The interface driver 116 also controls power supply to the wireless communicator 120 by a VBUS of the USB. Note that the electronic apparatus 100 has a function of shifting the communication connection between the processing section 110 and the wireless communicator 120 to a power-saving mode. Specifically, this function is, for example, a USB autosuspend function. With this function, when the communication between the processing section 110 and the wireless communicator 120 is interrupted for a predetermined period of time or more, the interface driver 116 stops a normal power supply to the wireless communicator 120 by the VBUS. Thus, power consumption is suppressed. That is, the interface driver 116 shifts the communication connection from a non-power-saving mode (active state) to a power-saving mode (suspend state). That is, a power supply state for the communication connection shifts from the non-power-saving mode (active state) to the power-saving mode (suspend state). Thereafter, when communication is started, the interface driver 116 starts the normal power supply again. That is, the interface driver 116 shifts the communication connection from the power-saving mode (suspend state) to the non-power-saving mode (active state). That is, the power supply state for the communication connection shifts from the power-saving mode (suspend state) to the non-power-saving mode (active state). The suspend state may be referred to as a sleep state.

The communication controller 114 controls wireless communication of the electronic apparatus 100. That is, the communication controller 114 controls communication of the wireless communicator 120. In this embodiment, the communication controller 114 executes not only the transmission control process for controlling transmission and reception of data by wireless communication, but also a process relating to failures in wireless communication in particular. Hereinafter, processing related to a failure in wireless communication performed by the communication controller 114 will be described. A failure in wireless communication refers to a state in which wireless communication may not be appropriately performed, and may also be referred to as a failure in a wireless connection.

The communication controller 114 performs a process of detecting occurrence of a failure in wireless communication (hereinafter also referred to as a failure detection process). In particular, the communication controller 114 detects the presence or absence of a failure caused by the electronic apparatus 100 by the failure detection process. When a failure is detected by the failure detection process, the communication controller 114 executes a predetermined process for eliminating the failure, as will be described later. In this embodiment, the communication controller 114 performs two types of failure detection process (first failure detection process and second failure detection process).

In this embodiment, the communication controller 114 performs the first failure detection process when a predetermined event occurs. Details of the predetermined event will be described later. As the first failure detection process, the communication controller 114 transmits a signal for searching for the communication apparatus 200. Then, the communication controller 114 detects a failure in wireless communication based on whether a response to the signal has been received from the communication apparatus 200. To be specific, the communication controller 114 broadcasts a probe request that is a signal for searching for the communication apparatus 200. More specifically, the communication controller 114 broadcasts a probe request including a service set identifier (SSID) of the communication apparatus 200 with which a connection has been previously established. Then, the communication controller 114 detects the failure of the wireless communication depending on whether the electronic apparatus 100 can receive a probe response transmitted as a response by any of the communication apparatuses 200 that have received the probe request.

When the probe response cannot be received, the communication controller 114 determines that a failure has occurred in the wireless communication of the electronic apparatus 100. On the other hand, when receiving the probe response from the communication apparatus 200, the communication controller 114 determines that no failure has occurred in the wireless communication. For example, in a case where a plurality of communication apparatuses 200 constitute a mesh Wi-Fi network, the same SSID is set to the plurality of communication apparatuses 200. In this case, two or more communication apparatuses 200 may transmit a probe response in response to the probe request issued by the electronic apparatus 100. In this case, when receiving the probe response from any of the communication apparatuses 200, the communication controller 114 determines that no failure has occurred in the wireless communication.

Note that, in Wi-Fi, even when no failure occurs in the electronic apparatus 100, the electronic apparatus 100 may not be able to receive the probe response due to a disturbance. For this reason, the communication controller 114 may transmit a signal (probe request) for searching for the communication apparatus 200 a plurality of times. In this case, the communication controller 114 detects, based on whether a response to the signal has been received at least once from any of the communication apparatuses 200, a failure in wireless communication. In this case, the communication controller 114 determines that a failure has occurred in the wireless communication of the electronic apparatus 100, when no probe response can be received even though the probe request is transmitted a plurality of times. According to such a determination process, it is possible to prevent erroneous detection of a failure due to a failure to receive a response owing to a disturbance.

As described above, the communication controller 114 performs the first failure detection process using the occurrence of a predetermined event as a trigger. Here, the predetermined event is an event that causes a shift of the communication connection between the processing section 110 and the wireless communicator 120 from the power-saving mode to the non-power-saving mode. Specifically, for example, the predetermined event may be an event in which the wireless communicator 120 may not receive a signal (beacon) periodically transmitted from the communication apparatus 200. Hereinafter, this event is referred to as a beacon non-reception event. More specifically, the beacon non-reception event is an event in which a beacon from a specific one of the communication apparatuses 200, which has been periodically received, cannot be received. When such an event occurs, the wireless communication circuit 121 of the wireless communicator 120 notifies the processing section 110 of the occurrence of the event. In this notification, when the communication connection between the processing section 110 and the wireless communicator 120 is in the power-saving mode, the wireless communication circuit 121 outputs a signal, to the processing section 110 via the bus 60, for requesting the processing section 110 to bring the communication connection into a non-power-saving mode in order to transmit a message indicating the occurrence of the event to the processing section 110. When the processing section 110 receives a signal requesting return to the non-power-saving mode, the interface driver 116 shifts the communication connection from the power-saving mode to the non-power-saving mode. Thereafter, the wireless communication circuit 121 transmits a message for notifying the processing section 110 of the occurrence of the above-described event. Note that the wireless communication circuit 121 determines that a beacon non-reception event has occurred, for example, when non-reception of a beacon from the specific one of the communication apparatuses 200, which has been periodically received, continues for a predetermined period of time (for example, one second).

Furthermore, the predetermined event may be an event in which the wireless communicator 120 receives a disconnection notification from the communication apparatus 200. Hereinafter, this event is referred to as a disconnection notification event. For example, depending on a model, an access point may have a function of periodically (for example, at intervals of 30 minutes) disconnecting wireless connection with a client as a function for ensuring security. In a case where the communication apparatus 200 has such a function, when a periodic disconnection timing arrives, the communication apparatus 200 transmits a disconnection notification to the electronic apparatus 100 and disconnects the wireless connection. Even when such an event occurs, the wireless communication circuit 121 of the wireless communicator 120 notifies the processing section 110 of the occurrence of the event. Also in this case, when the communication connection between the processing section 110 and the wireless communicator 120 is in the power-saving mode, the wireless communication circuit 121 outputs a signal for requesting the processing section 110 to set the communication connection to the non-power-saving mode in order to transmit a message for notifying the processing section 110 of the occurrence of the event. Then, when the communication connection is shifted from the power-saving mode to the non-power-saving mode by the interface driver 116, the wireless communication circuit 121 transmits a message for notifying the processing section 110 of the occurrence of the above-described event.

Note that, for the convenience of the user of the electronic apparatus 100, the electronic apparatus 100 preferably continues the wireless connection with the communication apparatus 200. For this reason, in a case where the electronic apparatus 100 may not appropriately establish a wireless connection with the communication apparatus 200, it is necessary to execute a wireless connection process, and the wireless connection process is executed under the control of the processing section 110. Therefore, when the beacon non-reception event or the disconnection notification event occurs, the wireless communicator 120 according to this embodiment immediately notifies the processing section 110, which is an execution subject of the wireless connection process, of the occurrence of the event.

When a response (probe response) to the signal (probe request) for searching for the communication apparatus 200 transmitted in the first failure detection process is received, the communication controller 114 executes a process of establishing a connection in wireless communication with the communication apparatus 200 that has transmitted the response. That is, when no failure is detected in the first failure detection process, the communication controller 114 executes a wireless connection process for establishing a wireless communication connection with the communication apparatus 200 that has transmitted the response. For example, the communication controller 114 executes a process according to the Wi-Fi standard as the wireless connection process. Specifically, as the wireless connection process, the communication controller 114 performs an authentication and association process in accordance with the Wi-Fi standard with the communication apparatus 200. Note that, when receiving responses (probe responses) to the signal (probe request) for searching for the communication apparatus 200 from the plurality of communication apparatuses 200, the communication controller 114 executes a process of establishing a connection in wireless communication with the communication apparatus 200 selected based on a radio wave intensity of the response. Specifically, for example, the communication controller 114 executes a process of establishing a connection in wireless communication with the communication apparatus 200 having the highest radio wave intensity of a response. Thus, a stable wireless connection can be established. Note that a portion or all of the above-described wireless connection process may be executed by the wireless chip driver 115 under the control of the communication controller 114.

On the other hand, when the communication controller 114 cannot receive a response (probe response) to the signal (probe request) for searching for the communication apparatus 200 transmitted in the first failure detection process, the communication controller 114 executes a recovery process to be described below. That is, when a failure is detected in the first failure detection process, the communication controller 114 executes the recovery process. After that, the communication controller 114 executes the wireless connection process for establishing a connection in wireless communication with the communication apparatus 200.

Furthermore, as the second failure detection process, the communication controller 114 determines whether a failure has occurred in the wireless communication by periodically transmitting a packet to the communication apparatus 200. That is, the communication controller 114 detects a failure in wireless communication by transmitting a packet to the communication apparatus 200. The communication controller 114 performs transmission of a packet, for example, at intervals of 10 minutes. More specifically, the communication controller 114 determines a state of wireless communication connection of the wireless communicator 120 by executing a ping command and transmitting a packet to the communication apparatus 200. That is, the communication controller 114 determines whether a failure has occurred in the wireless communication by checking a response to the packet transmitted by the execution of the ping command. When a response is obtained from the communication apparatus 200, the communication controller 114 determines that no failure has occurred in the wireless communication performed by the wireless communicator 120. On the other hand, when a response is not obtained from the communication apparatus 200, the communication controller 114 determines that a failure has occurred in the wireless communication performed by the wireless communicator 120.

Note that, in this embodiment, in a case where the above-described predetermined event (the beacon non-reception event or the disconnection notification event) occurs, the communication controller 114 suspends the second failure detection process to be performed by transmission of a packet at least until the connection of the wireless communication with the communication apparatus 200 is established. Thus, it is possible to prevent the first failure detection process and the second failure detection process from being executed in an overlapping manner. In particular, while the wireless connection between the electronic apparatus 100 and the communication apparatus 200 is disconnected due to occurrence of a disconnection notification event, transmission and reception of packets to and from the communication apparatus 200 fail. For this reason, when the second failure detection process is performed before the connection in the wireless communication with the communication apparatus 200 is reestablished, it is erroneously detected that a failure has occurred in the wireless communication function of the communication apparatus 200. As a result, the recovery process to be described later is executed, although it is unnecessary. On the other hand, as described above, by suppressing the execution of the second failure detection process in a period of time from the occurrence of the event to the establishment of the connection in the wireless communication with the communication apparatus 200, it is possible to avoid execution of an unnecessary recovery process.

In a case where it is determined that a failure has occurred in the wireless communication of the electronic apparatus 100, the communication controller 114 executes a predetermined process for solving the failure that has occurred (hereinafter also referred to as a recovery process). By executing the recovery process, it is possible to solve the failure of the wireless communication function that has occurred in the electronic apparatus 100. The recovery process may be referred to as a failure elimination process. In this embodiment, when it is determined that a failure has occurred in the wireless communication, the communication controller 114 executes at least one of the following three recovery processes as the recovery process. However, these are merely specific examples of the recovery process, and the communication controller 114 may execute a predetermined recovery process different from the following three recovery processes.

The communication controller 114 reinstalls the wireless chip driver 115 as the first recovery process. That is, the communication controller 114 uninstalls the wireless chip driver 115 and installs the uninstalled wireless chip driver 115.

The wireless chip driver 115 is stored in, for example, the ROM 164, and the driver is installed by reading the wireless chip driver 115 from the ROM 164. That is, the wireless chip driver 115 is installed in an execution program of the processor 111 so as to be executable. In the first recovery process, first, the communication controller 114 uninstalls the installed wireless chip driver 115. That is, uninstallation for deleting the wireless chip driver 115 from the execution program of the processor 111 is performed. At this time, the communication controller 114 may initialize various settings set in a register or the like of the wireless communication circuit 121 by performing a negotiation process or the like with the wireless communicator 120. Then, in the first recovery process, after the uninstallation, the communication controller 114 reinstalls the wireless chip driver 115 from the ROM 164. Accordingly, in a case where there is a defect in the register setting or the like of the wireless communication circuit 121 controlled by the wireless chip driver 115 or there is a defect in the wireless chip driver 115, the defect can be solved. For example, even when the register setting of the wireless communication circuit 121 is lost or changed to an erroneous setting, the register setting or the like of the wireless communication circuit 121 can be recovered to a correct setting by the wireless chip driver 115 newly installed after uninstallation. In addition, by uninstalling the wireless chip driver 115, it is possible to reset a state of the memory used in the wireless chip driver 115. Therefore, by executing the first recovery process, it is possible to solve a failure of the wireless communication caused by occurrence of a problem in an operation of the wireless chip driver 115 or an operation of the wireless communicator 120.

Furthermore, as the second recovery process, the communication controller 114 cuts off the power supply to the wireless communicator 120 and resumes the power supply after the power supply is cut off. That is, the communication controller 114 executes a hardware reset of the wireless communicator 120 as the second recovery process. For example, when power is supplied to the wireless communicator 120 through the VBUS of the USB, first, the communication controller 114 does not supply the power through the VBUS. Then, after the power supply is cut off, the communication controller 114 resumes the power supply by the VBUS. In this embodiment, specifically, the communication controller 114 instructs the interface driver 116 to cut off the power supply to the wireless communicator 120. In addition, the communication controller 114 instructs the interface driver 116 to resume the power supply to the wireless communicator 120. Thus, the power supply to the wireless communicator 120 is cut off and resumed. Since the register setting and the like of the wireless communication circuit 121 are initialized by cutting off and resuming the power supply as described above, the failure of the wireless communication can be resolved.

In addition, the communication controller 114 reboots the communication controller 114 itself as a third recovery process. That is, the communication controller 114 reboots software operating as the communication controller 114. A failure may occur in the wireless communication due to a failure in the transmission control process executed by the communication controller 114. In such a case, when the communication controller 114 is rebooted, an operational state of the software functioning as the communication controller 114 and a state of the memory used for the operation of the software can be returned to states at a time of the activation of the software. Thus, the operation of the software can be stabilized, and the failure of the wireless communication can be resolved.

When it is determined that a failure has occurred in the wireless communication, the communication controller 114 may execute any one of the plurality of predetermined recovery processes, or may sequentially execute two or more processes.

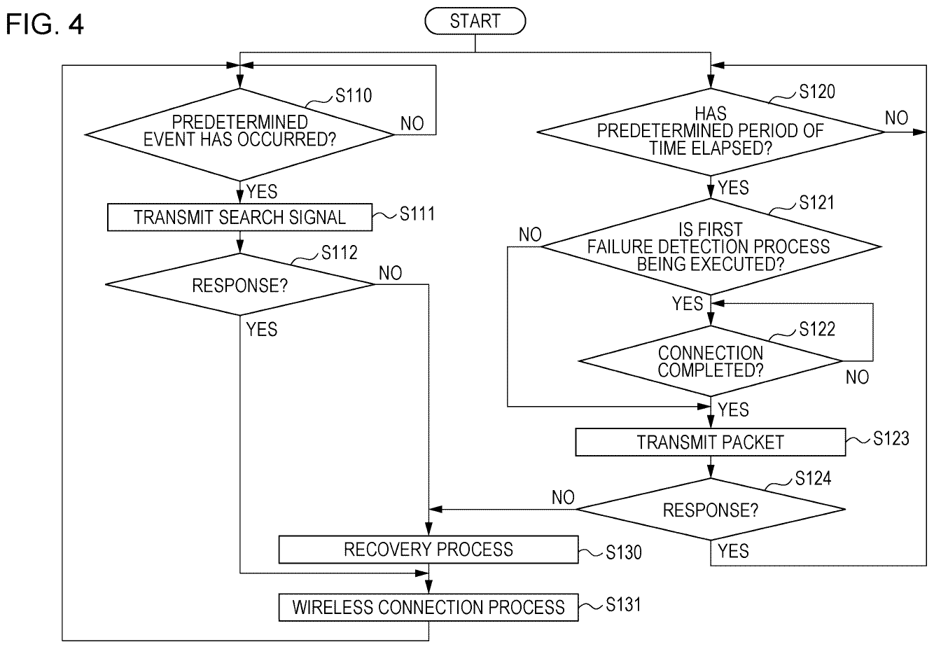

Next, a flow of an operation of the processing section 110 related to detection of a failure in the wireless communication of the electronic apparatus 100 will be described. FIG. 4 is a flowchart illustrating an example of a flow of an operation of the processing section 110. The flow of the operation will be described below with reference to FIG. 4. Note that this flow is started, for example, when the electronic apparatus 100 establishes a wireless connection with the communication apparatus 200, but this flow may be started at any timing.

As illustrated in FIG. 4, the processing section 110 performs a process from step S110 to step S112, which is related to the first failure detection process, and a process from step S120 to step S124, which is related to the second failure detection process, in parallel.

First, the process from step S110 to step S112, which is related to the first failure detection process, will be described.

In step S110, the communication controller 114 determines whether the above-described predetermined event (the beacon non-reception event or the disconnection notification event) has occurred. When the predetermined event has occurred (YES in step S110), the process proceeds to step S111. Note that the communication controller 114 determines that the event has occurred based on a notification supplied from the wireless communicator 120 that has detected the occurrence of the event. Therefore, when the process proceeds to step S111, a power mode of the communication connection between the processing section 110 and the wireless communicator 120 is the non-power-saving mode. Note that the communication controller 114 may acquire the notification from the wireless communicator 120 that has detected the occurrence of the event via the wireless chip driver 115.

In step S111, the communication controller 114 transmits a search signal (probe request) for searching for the communication apparatus 200 as the first failure detection process. Subsequently, in step S112, the communication controller 114 determines whether a response (probe response) has been received from any of the communication apparatuses 200 that have received the search signal. If a response is not obtained (NO in step S112), the communication controller 114 determines that a failure has occurred in the wireless communication function of the electronic apparatus 100. In this case, the process proceeds to step S130 (recovery process). On the other hand, when a response is obtained (YES in step S112), the process proceeds to step S131 (wireless connection process).

Next, the process from step S120 and step S124, which is related to the second failure detection process, will be described.

In step S120, the communication controller 114 determines whether a predetermined period of time, which is a transmission interval of a ping packet in the second failure detection process, has elapsed. When the predetermined period of time has elapsed (YES in step S120), the process proceeds to step S121.

In step S121, the communication controller 114 determines whether the first failure detection process is being executed. That is, the communication controller 114 determines whether the process from step S111 onwards is being executed. When the first failure detection process is being executed (YES in step S121), the process proceeds to step S122. In contrast, when the first failure detection process is not being executed (NO in step S121), the process skips step S122 and proceeds to step S123.

In step S122, the communication controller 114 determines whether the wireless connection process (step S131 described later) performed after the first failure detection process is completed. That is, the communication controller 114 determines whether a reconnection of the wireless communication between the electronic apparatus 100 and the communication apparatus 200 has been completed. When the connection of the wireless communication by the wireless connection process performed after the first failure detection process has been completed (YES in step S122), the process proceeds to step S123. On the other hand, in a case where the connection of the wireless communication is not completed (NO in step S122), execution of subsequent step S123 (packet transmission of the second failure detection process) is suspended until the connection is completed.

When the process proceeds to step S123, the communication controller 114 executes the second failure detection process. Specifically, the communication controller 114 executes a ping command and transmits a packet to the communication apparatus 200. That is, the communication controller 114 transmits a packet addressed to an IP address of the communication apparatus 200 by using the wireless communicator 120. After step S123, the process proceeds to step S124. In step S124, the communication controller 114 determines whether a response to the packet transmitted in step S123 has been obtained. When a response is received from the communication apparatus 200 (YES in step S124), the communication controller 114 determines that no failure has occurred in the wireless communication function of the electronic apparatus 100. In this case, the process returns to step S120. When a response from the communication apparatus 200 is not obtained (NO in step S124), the communication controller 114 determines that a failure has occurred in the wireless communication function of the electronic apparatus 100. In this case, the process proceeds to step S130.

In step S130, the communication controller 114 executes a recovery process. In this embodiment, the communication controller 114 executes at least one of the first to third recovery processes described above. After step S130, the process proceeds to step S131.

In step S131, the communication controller 114 executes a wireless connection process for establishing a connection in wireless communication with the communication apparatus 200. After step S131, the process returns to step S110 or step S120.

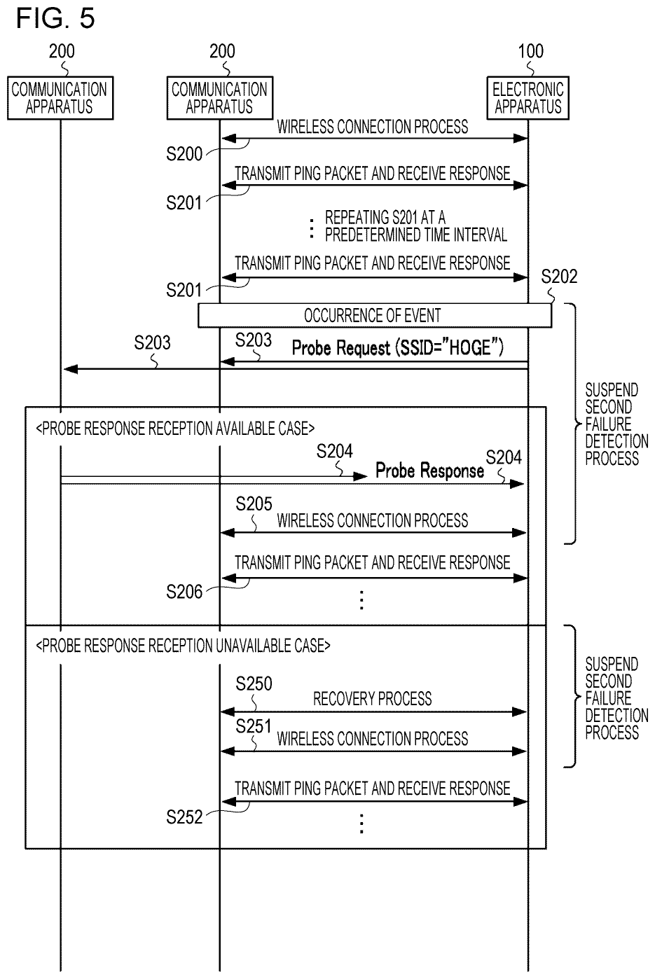

FIG. 5 is a sequence chart illustrating an example of operations of the electronic apparatus 100 and the communication apparatus 200. Note that the sequence chart in FIG. 5 illustrates an operation example of an environment including two communication apparatuses 200 (the first communication apparatus 200 and the second communication apparatus 200) having the same SSID (for example, “HOGE”).

First, a wireless connection process is performed between the electronic apparatus 100 and the first communication apparatus 200, and a connection in wireless communication between the two is established (step S200). Thereafter, the second failure detection process is periodically executed (step S201). That is, transmission of a ping packet and reception of a response are repeatedly performed at predetermined time intervals.

Thereafter, when the above-described predetermined event (the beacon non-reception event or the disconnection notification event) occurs (step S202), the electronic apparatus 100 executes the first failure detection process. Specifically, the electronic apparatus 100 broadcasts a probe request for searching for the communication apparatus 200 with which the wireless communication with the electronic apparatus 100 has been established by the wireless connection process in step S200 (step S203).

In a case where the electronic apparatus 100 can receive a probe response transmitted by the communication apparatus 200 as a response to the probe request, the electronic apparatus 100 operates as follows. When receiving the probe response (step S204), the electronic apparatus 100 executes a wireless connection process for establishing a connection in wireless communication with the communication apparatus 200 that has transmitted the probe response (step S205). Note that, when the probe response is received from the plurality of communication apparatuses 200, the electronic apparatus 100 executes, for example, a process of establishing a connection in wireless communication with the communication apparatus 200 selected based on radio wave intensity of the response. When the connection of the wireless communication between the electronic apparatus 100 and the communication apparatus 200 is established, the second failure detection process is resumed (step S206). That is, the second failure detection process is suspended in a period of time from step S202 to step S205.

On the other hand, when the electronic apparatus 100 may not receive a response (probe response) to the probe request, the electronic apparatus 100 operates as follows. The electronic apparatus 100 executes the recovery process of the wireless communication function (step S250). After that, the electronic apparatus 100 executes a wireless connection process for establishing a connection in the wireless communication with the communication apparatus 200 (step S251). Note that, as the wireless connection process, a wireless connection process by active scanning, which is a process of establishing a wireless connection by transmitting a probe request, may be executed, or passive scanning for establishing a wireless connection by receiving a beacon periodically transmitted by the communication apparatus 200 may be executed. Also in step S251, the communication apparatus 200 of a connection partner may be selected based on radio wave intensity of the signal transmitted by each of the communication apparatuses 200. When the connection of the wireless communication between the electronic apparatus 100 and the communication apparatus 200 is established, the second failure detection process is resumed (step S252). That is, the second failure detection process is suspended from step S202 to step S251.

Next, in order to facilitate understanding of the features of the electronic apparatus 100 according to the embodiment, a comparative example will be described. An electronic apparatus 900 according to the comparative example is different from the electronic apparatus 100 according to the embodiment in that only the second failure detection process (failure detection by transmission of a ping packet) is performed and the first failure detection process is not performed.

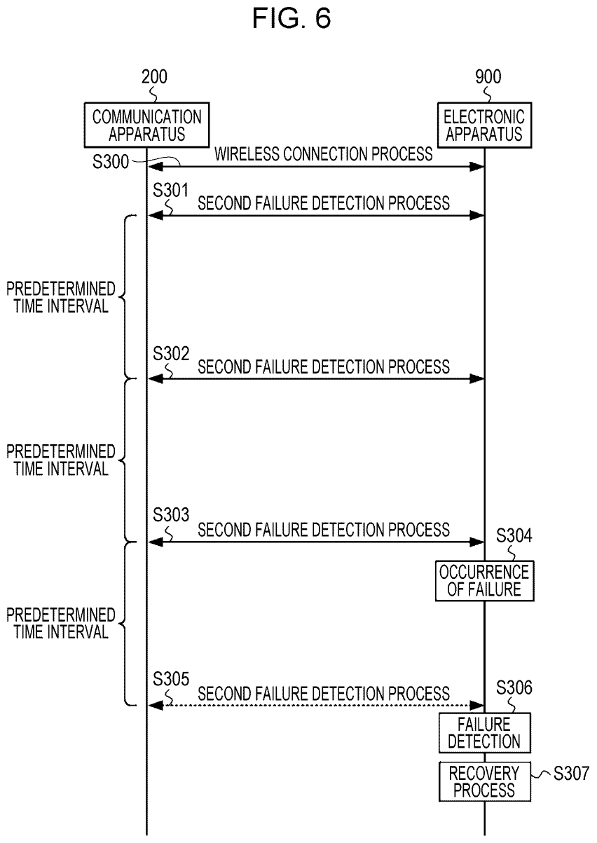

FIG. 6 is a sequence chart illustrating a first operation example of the electronic apparatus 900 according to the comparative example. Hereinafter, the first operation example of the electronic apparatus 900 will be described with reference to the sequence chart shown in FIG. 6.

First, a wireless connection process is performed between the electronic apparatus 900 and the communication apparatus 200, and a connection in wireless communication is established therebetween (step S300). Thereafter, the second failure detection process is periodically executed (from step S301 to step S303). That is, transmission of a ping packet and reception of a response are repeatedly performed at predetermined time intervals. It is assumed here that a failure occurs in a wireless communication function of the electronic apparatus 900 immediately after the second failure detection process in step S303 is executed (step S304). In this case, in the electronic apparatus 900 according to the comparative example, when a predetermined period of time elapses and the second failure detection process in step S305 is executed, a failure is detected (step S306) and the recovery process is executed (step S307). Therefore, even when a failure occurs in the electronic apparatus 900 according to the comparative example, the failure may not be immediately detected, and recovery may be delayed.

In order to solve this problem, it is conceivable to shorten a transmission interval of the ping packet. However, frequent transmission and reception of ping packets may increase power consumption. This is because, even when the electronic apparatus 900 has shifted to a power-saving mode due to continuation of a state in which no communication occurs for a predetermined period of time or more, shift to a non-power-saving mode is required for transmission of a ping packet. Therefore, it is not preferable to reduce a transmission interval of the ping packet from the viewpoint of power consumption.

On the other hand, in this embodiment, the first failure detection process is performed as described above. The first failure detection process is performed when an event that causes a shift from the power-saving mode to the non-power-saving mode occurs. Accordingly, whether the first failure detection process is to be performed has almost no influence on the power consumption. Therefore, according to the electronic apparatus 100, it is possible to detect a failure at an early stage without increasing power consumption. Consequently, according to this embodiment, it is possible to appropriately detect a failure.

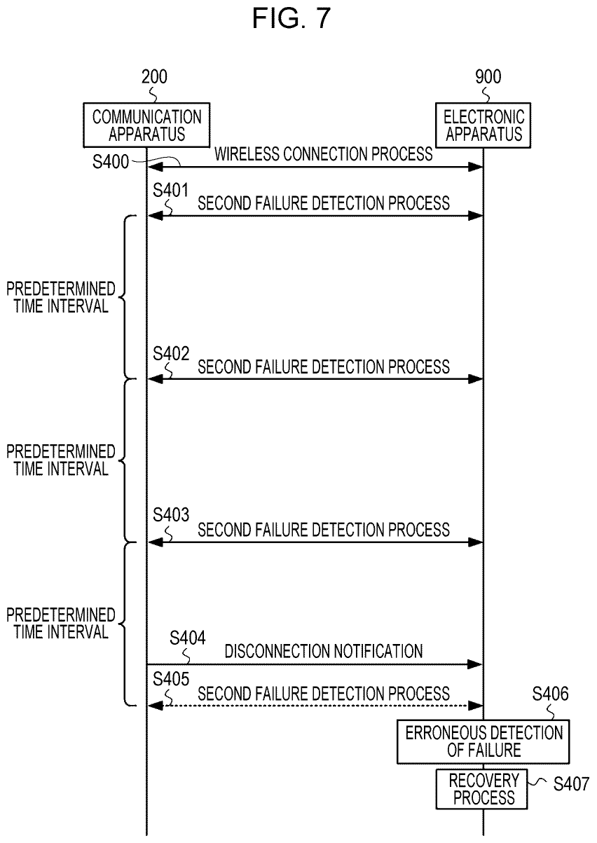

FIG. 7 is a sequence chart of a second operation example of the electronic apparatus 900 according to the comparative example. Hereinafter, the second operation example of the electronic apparatus 900 will be described with reference to the sequence chart shown in FIG. 7. Note that, in the example illustrated in FIG. 7, it is assumed that the communication apparatus 200 has a function of periodically disconnecting a wireless connection with a client as a function of ensuring security.

First, a wireless connection process is performed between the electronic apparatus 900 and the communication apparatus 200, and a wireless communication connection is established therebetween (step S400). Thereafter, the second failure detection process is periodically executed (from step S401 to step S403). That is, transmission of a ping packet and reception of a response are repeatedly performed at predetermined time intervals. It is assumed here that the electronic apparatus 900 receives a disconnection notification from the communication apparatus 200 in step S404. That is, in step S404, it is assumed that a disconnection process is executed by the security function of the communication apparatus 200. Thereafter, when an execution timing of the second failure detection process arrives, the electronic apparatus 900 executes the second failure detection process in step S405. At this time, since the wireless connection between the communication apparatus 200 and the electronic apparatus 900 is disconnected, the transmission and reception of the ping packet fails. Therefore, even when no failure has occurred in the wireless communication function of the electronic apparatus 900, it is determined that a failure has occurred. That is, a failure is erroneously detected (step S406), and a recovery process is unnecessarily executed (step S407).

On the other hand, in this embodiment, as described above, when the disconnection process is executed by the communication apparatus 200, the second failure detection process is suspended until reconnection between the communication apparatus 200 and the electronic apparatus 100 is completed. Therefore, unnecessary execution of the recovery process due to erroneous detection of a failure is suppressed.

Although the embodiments have been described above, the present disclosure is not limited to the above-described embodiments, and can be appropriately modified without departing from the scope of the disclosure. For example, in the above-described embodiment, the electronic apparatus 100 executes both the first failure detection process and the second failure detection process, but may execute only one of them (particularly, the first failure detection process). By executing not only the first failure detection process but also the second failure detection process, it is possible to improve the failure detection capability of the electronic apparatus 100 compared to a case where only the first failure detection process is executed.

In addition, in the above-described example, the program includes an instruction group (or software code) for causing a computer to perform one or more functions described in the embodiments when the program is read into the computer. The program may be stored in a non-transitory computer-readable medium or a tangible storage medium. By way of example, and not limitation, such a computer-readable medium or tangible storage medium may include a random-access memory (RAM), a read-only memory (ROM), a flash memory, a solid-state drive (SSD), and other memory technology, a CD-ROM, a digital versatile disc (DVD), a Blu-ray (registered trademark) disc, and other optical disc storage, a magnetic cassette, a magnetic tape, a magnetic disk storage, and another magnetic storage device. Each of the programs may be transmitted on a transitory computer-readable medium or a communication medium. By way of example, and not limitation, the transitory computer-readable medium or the communication medium includes electrical, optical, acoustical, or other forms of propagated signals.

Some or all of the above-described embodiments may be described as, but not limited to, the following appendices.

### Appendix 1

An electronic apparatus comprising: a wireless communicator that performs wireless communication with a communication apparatus; and a processing section that includes a communication controller that controls communication of the wireless communicator, wherein when an event that causes a shift of a communication connection between the processing section and the wireless communicator from a power-saving mode to a non-power-saving mode occurs, the communication controller transmits a signal for searching for the communication apparatus and detects a failure of the wireless communication depending on whether a response to the signal is received from the communication apparatus.

### Appendix 2

The electronic apparatus according to Appendix 1, wherein the event includes an event in which the wireless communicator does not receive a signal periodically transmitted from the communication apparatus.

### Appendix 3

The electronic apparatus according to Appendix 1 or 2, wherein the event includes an event in which the wireless communicator has received a disconnection notification from the communication apparatus.

### Appendix 4

The electronic apparatus according to any one of Appendices 1 to 3, the communication controller performs, when the failure is detected, a predetermined process for eliminating the failure.

### Appendix 5

The electronic apparatus according to any one of Appendices 1 to 4, wherein, when receiving the response to the signal from the communication apparatus, the communication controller executes a process of establishing a connection in wireless communication with the communication apparatus.

### Appendix 6

The electronic apparatus according to Appendix 5, wherein, when receiving the response to the signal from a plurality of communication apparatuses, each of which is the communication apparatus that performs wireless communication with the wireless communicator, the communication controller executes a process of establishing a connection in wireless communication with the communication apparatus selected based on radio wave intensity of the response.

### Appendix 7

The electronic apparatus according to any one of Appendices 1 to 6, wherein the communication controller further detects a failure in the wireless communication by transmitting a packet to the communication apparatus.

### Appendix 8

The electronic apparatus according to Appendix 7, wherein, when the event occurs, the communication controller stops the detection of the failure by the transmission of the packet at least until connection of the wireless communication with the communication apparatus is established.

### Appendix 9

The electronic apparatus according to any one of Appendices 1 to 8, wherein the communication controller transmits a signal for searching for the communication apparatus a plurality of times, and detects, based on whether a response to the signal has been received from the communication apparatus at least once, a failure in the wireless communication.

### Appendix 10

A control method of an electronic apparatus including a wireless communicator that performs wireless communication with a communication apparatus and a processing section including a communication controller that controls communication of the wireless communicator, wherein when an event that causes a shift of a communication connection between the processing section and the wireless communicator from a power-saving mode to a non-power-saving mode occurs, a signal for searching for the communication apparatus is transmitted, and a failure of the wireless communication is detected depending on whether a response to the signal is received from the communication apparatus.

What is claimed is:

1. An electronic apparatus comprising:
a wireless communicator that performs wireless communication with a communication apparatus; and
a processing section that includes a communication controller that controls communication of the wireless communicator, wherein
when an event that causes a shift of a communication connection between the processing section and the wireless communicator from a power-saving mode to a non-power-saving mode occurs, the communication controller transmits a signal for searching for the communication apparatus and detects a failure of the wireless communication depending on whether a response to the signal is received from the communication apparatus.

2. The electronic apparatus according to claim 1, wherein the event includes an event in which the wireless communicator does not receive a signal periodically transmitted from the communication apparatus.

3. The electronic apparatus according to claim 1, wherein the event includes an event in which the wireless communicator has received a disconnection notification from the communication apparatus.

4. The electronic apparatus according to claim 1, wherein the communication controller performs, when the failure is detected, a predetermined process for eliminating the failure.

5. The electronic apparatus according to claim 1, wherein, when receiving the response to the signal from the communication apparatus, the communication controller executes a process of establishing a connection in wireless communication with the communication apparatus.

6. The electronic apparatus according to claim 5, wherein, when receiving the response to the signal from a plurality of communication apparatuses, each of which is the communication apparatus that performs wireless communication with the wireless communicator, the communication controller executes a process of establishing a connection in wireless communication with the communication apparatus selected based on radio wave intensity of the response.

7. The electronic apparatus according to claim 1, wherein the communication controller further detects a failure in the wireless communication by transmitting a packet to the communication apparatus.

8. The electronic apparatus according to claim 7, wherein, when the event occurs, the communication controller stops the detection of the failure by the transmission of the packet at least until connection of the wireless communication with the communication apparatus is established.

9. The electronic apparatus according to claim 1, wherein the communication controller transmits a signal for searching for the communication apparatus a plurality of times, and detects, based on whether a response to the signal has been received from the communication apparatus at least once, a failure in the wireless communication.

10. A control method of an electronic apparatus including a wireless communicator that performs wireless communication with a communication apparatus and a processing section including a communication controller that controls communication of the wireless communicator, wherein when an event that causes a shift of a communication connection between the processing section and the wireless communicator from a power-saving mode to a non-power-saving mode occurs, a signal for searching for the communication apparatus is transmitted, and a failure of the wireless communication is detected depending on whether a response to the signal is received from the communication apparatus.
